(19) United States
(12) Patent Application Publication
(10) Pub. No.: US 2025/0033403 A1
(43) Pub. Date: Jan. 30, 2025

(54) WHITEBOARD SYSTEM

(71) Applicant: SABLE DESIGNS LLC, Austin, TX (US)

(72) Inventor: Tomer SORAN, Austin, TX (US)

(21) Appl. No.: 18/709,186

(22) PCT Filed: Nov. 16, 2022
(86) PCT No.: PCT/US2022/050106

§ 371 Date: May 10, 2024

Related U.S. Application Data
(60) Provisional application No. 63/280,475, filed on Nov. 17, 2021.

(51) Int. Cl. B43L 1/00; A47B 97/00

(52) U.S. Cl. CPC B43L 1/00; A47B 97/001

(57) ABSTRACT

Disclosed is a whiteboard system including a base structure and a frame structure constructed of frame members and affixed to the base structure in such a way that the frame structure is moveable between a closed position and an open position. The whiteboard system further includes one or more hinge mechanisms coupled between the base structure and the frame structure. The hinge mechanism(s) is positioned between the base structure and the frame structure when the frame structure is moved to the closed position and is at least partially recessed within at least one of the base structure and the frame structure. Additionally, the whiteboard system includes one or more writing panels mounted to at least one of the base structure and the frame structure in such a way that when the frame structure is in the closed position the writing panel(s) is concealed from view by the frame structure, and when the frame structure is in the open position the at least one writing panel is displayed. The hinge mechanism(s) is further configured to be hidden from view when the frame structure is in the closed position.

### TECHNICAL FIELD AND BACKGROUND OF THE INVENTION

The present disclosure relates generally to the field of whiteboards, or, more particularly, to whiteboard systems and support structures and support assemblies suitable for use with whiteboards.

Academics, businesses, and numerous other organizations commonly utilize whiteboards to assist in conveying information in a collaborative setting to audiences of various ages and sophistications. Whiteboards, such as dry-erase boards, marker boards, and the like, generally include a glossy, usually white surface suitable to make temporary markings. Whiteboards are typically used as a replacement for, and are analogous to, antiquated blackboards. Whiteboards are generally defined by an ability to written upon with appropriate ink markers and the like and then easily erased. Typically, a whiteboard includes a material, such as melamine, used in conjunction with an appropriate erasable marker to allow writing to be removed, to a substantial degree.

During current practices, a large whiteboard typically 10 square feet or more in size is temporarily or permanently fixed to a structure and utilized as a tool to help convey information. Whiteboards typically require suitable marking and erasing devices. A user must manage and/or transport the suitable devices, materials, and the like. However, associated items for a fixed whiteboard may be easily lost or misplaced. When transporting or setting up a temporary whiteboard presentation, the presenter is required to transport and/or locate the necessary marking and erasing devices. Though whiteboards are often desired and would provide assistance in communicating information, the inconvenience of transporting and securing a whiteboard and the associated items frequently makes whiteboard use impractical or unfeasible.

Furthermore, current whiteboards are generally aesthetically displeasing and do not provide mechanisms for individual expression. Users of such whiteboards are often forced to accommodate a large, cumbersome, and dull whiteboard at least semi-permanently fixed at the desired presentation location. Alternatively, current, large whiteboards may be stored and set up in a presentation location, when desired, and stored out of sight, when not desired. However, the annoyance of setting up a typical whiteboard, the necessary support structure, and the required devices often results in the avoidance of using the same. Further, a user may choose not to set up an available whiteboard in order to maintain a desired aesthetic appearance.

As such, a need exists in the art for an improved whiteboard system that overcomes the above limitations.

### BRIEF SUMMARY OF THE INVENTION

Therefore, it is an object of the invention to provide whiteboard systems that overcome the limitation of the known art. Disclosed whiteboard systems are configured to provide a desirable aesthetic appearance. Further, whiteboard systems disclosed herein allow for movement of a media display in order to hide one or more interior whiteboards, such as rotation on one or more hinges. More particularly, the whiteboard systems may include one or more hinge mechanisms that are hidden when the media display is closed in order to maintain a pleasing aesthetic. At least one embodiment of the whiteboard system may further include a retention mechanism to secure media elements slid into media display. Additionally, or alternatively, exemplary whiteboards disclosed herein may include magnetic fasteners to maintain the media display in a closed position, when desired.

To achieve the foregoing and other objects and advantages, in one aspect, the present subject matter is directed to a whiteboard system. The whiteboard system includes a base structure adapted to be wall mounted. The whiteboard system further includes a frame structure constructed of two or more frame members. The frame structure is affixed to the base structure in such a way that the frame structure is moveable between a closed position and an open position. The whiteboard system further includes one or more hinge mechanisms coupled between the base structure and the frame structure. The hinge mechanism(s) is positioned between the base structure and the frame structure when the frame structure is moved to the closed position. Further, the hinge mechanism(s) is at least partially recessed within at least one of the base structure and the frame structure. Additionally, the whiteboard system includes one or more writing panels mounted to at least one of the base structure and the frame structure in such a way that when the frame structure is in the closed position the writing panel(s) is concealed from view by the frame structure, and when the frame structure is in the open position the at least one writing panel is displayed. The hinge mechanism(s) is further configured to be hidden from view when the frame structure is in the closed position.

In one embodiment, the hinge mechanism(s) is further configured to allow the whiteboard system to fully close when the frame structure is in the closed position. In additional or alternative embodiments, each of the frame members has a groove that defines a panel receiving space along an interior side of the frame structure, and at least one of the frame members having a slot that provides access to the panel receiving space such that a display panel may be inserted into and removed from the panel receiving space. In additional or alternative embodiments, each of the frame members has a groove that defines a panel receiving space along an interior side of the frame structure. Additionally, writing panel(s) is mounted to at least one of the base structure and the frame structure in such a way that when the frame structure is in the closed position the display panel inserted in the panel receiving space is displayed. In additional or alternative embodiments, the frame structure cover defines a first angular orientation relative to the base structure when the frame structure is in the closed position, and the frame structure defines a second angular orientation, different than the first angular orientation, relative to the base structure when the frame structure is in the open position.

In additional or alternative embodiments, when the frame structure is in the closed position, the hinge mechanism(s) is fully recessed within at least one of the base structure and the frame structure. In additional or alternative embodiments, hinge mechanism(s) includes a mechanical hinge. In additional or alternative embodiments, hinge mechanism(s) includes a mechanical hinge assembly.

Embodiments of the invention can include one or more or any combination of the above features and configurations.

Additional features, aspects, and advantages of the invention will be set forth in the detailed description that follows, and in part will be readily apparent to those skilled in the art from that description or recognized by practicing the invention as described herein. It is to be understood that both the foregoing general description and the following detailed description present various embodiments of the invention, and are intended to provide an overview or framework for understanding the nature and character of the invention as it is claimed. The accompanying drawings are included to provide a further understanding of the invention, and are incorporated in and constitute a part of this specification.

### BRIEF DESCRIPTION OF THE DRAWINGS

A full and enabling disclosure of the present invention, including the best mode thereof, directed to one of ordinary skill in the art, is set forth in the specification, which makes reference to companying drawings, in which:

FIG. 1 illustrates a perspective view of one embodiment of a whiteboard system in accordance with aspects of the present subject matter;

FIG. 2 illustrates a perspective view of the whiteboard system shown in a partially open condition, in accordance with aspects of the present subject matter;

FIG. 3 illustrates a perspective view of the whiteboard system shown in a fully open condition, in accordance with aspects of the present subject matter;

FIG. 4 illustrates a rear perspective view of the whiteboard system, in accordance with aspects of the present subject matter;

FIG. 5 illustrates a pictorial view of an upper hinge mechanism suitable for use with the whiteboard system, in accordance with aspects of the present subject matter;

FIG. 6 illustrates a pictorial view of lower hinge mechanism suitable for use with the whiteboard system, in accordance with aspects of the present subject matter;

FIG. 7 illustrates a pictorial view a hinge mechanism suitable for use with the whiteboard system, in accordance with aspects of the present subject matter;

FIG. 8 illustrates a pictorial, schematic view an additional or alternative hinge mechanism suitable for use with the whiteboard system, in accordance with aspects of the present subject matter; and

FIG. 9 illustrates a pictorial view a media retainer suitable for use with the whiteboard system, in accordance with aspects of the present subject matter.

Repeat use of reference characters in the present specification and drawings is intended to represent the same or analogous features or elements of the present invention.

### DETAILED DESCRIPTION OF THE INVENTION

The present invention will now be described more fully hereinafter with reference to the accompanying drawings in which exemplary embodiments of the invention are shown. However, the invention may be embodied in many different forms and should not be construed as limited to the representative embodiments set forth herein. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. It is envisioned that other embodiments may perform similar functions and/or achieve similar results. Any and all such equivalent embodiments and examples are within the scope of the present invention and are intended to be covered by the appended claims.

The exemplary embodiments are provided so that this disclosure will be both thorough and complete, and will fully convey the scope of the invention and enable one of ordinary skill in the art to make, use, and practice the invention.

The terms “coupled,” “fixed,” “attached to,” and the like refer to both direct coupling, fixing, or attaching, as well as indirect coupling, fixing, or attaching through one or more intermediate components or features, unless otherwise specified herein.

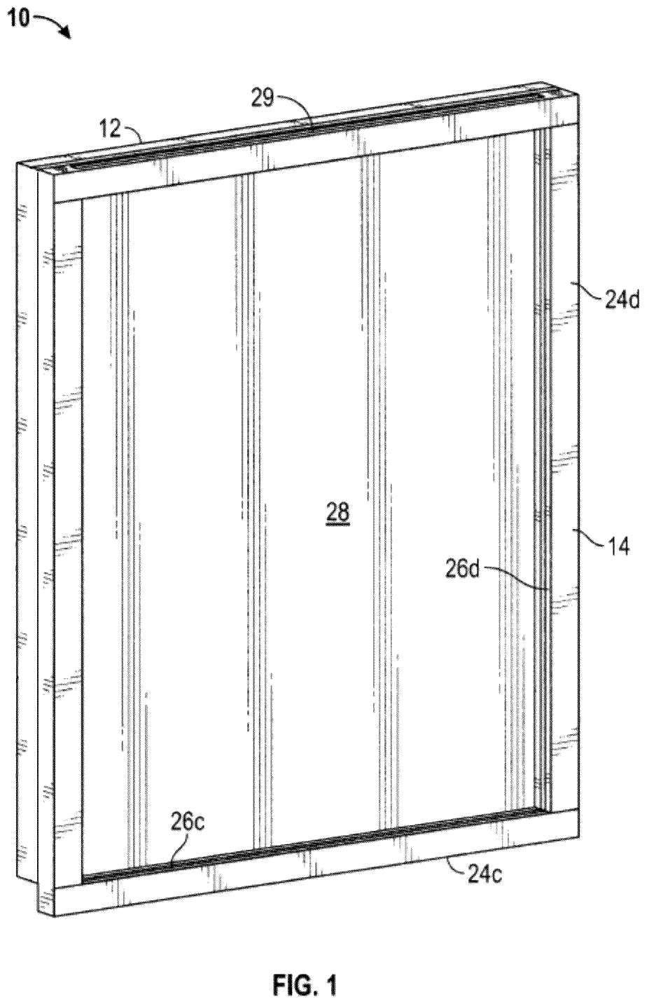

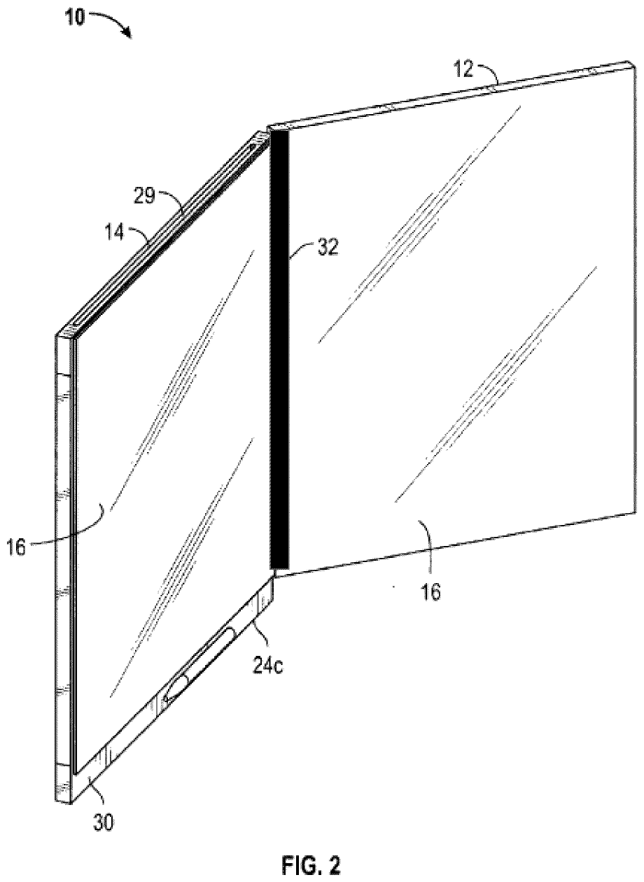

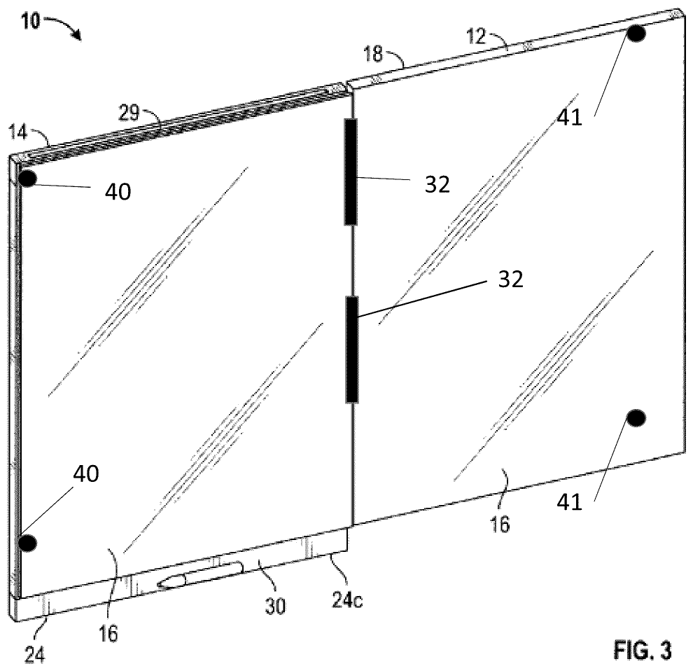

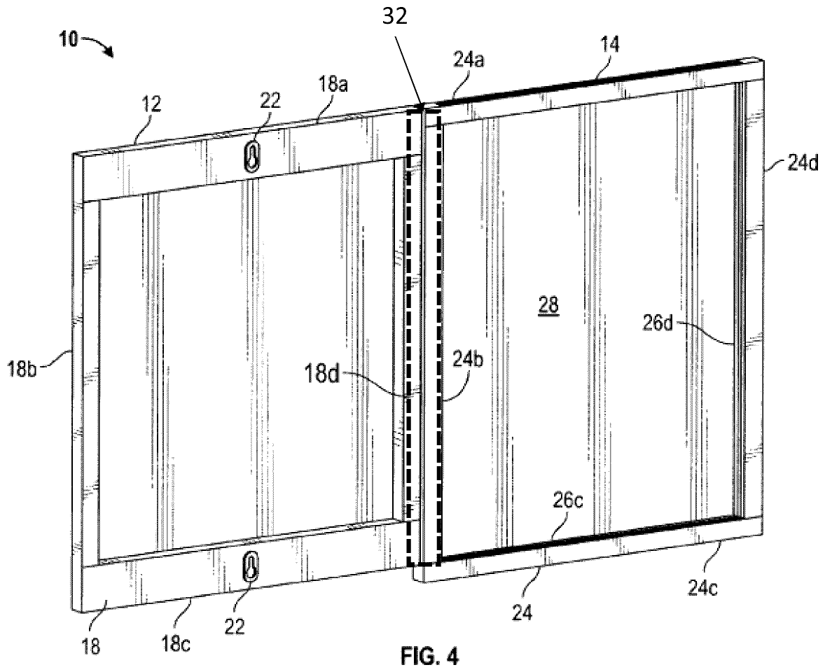

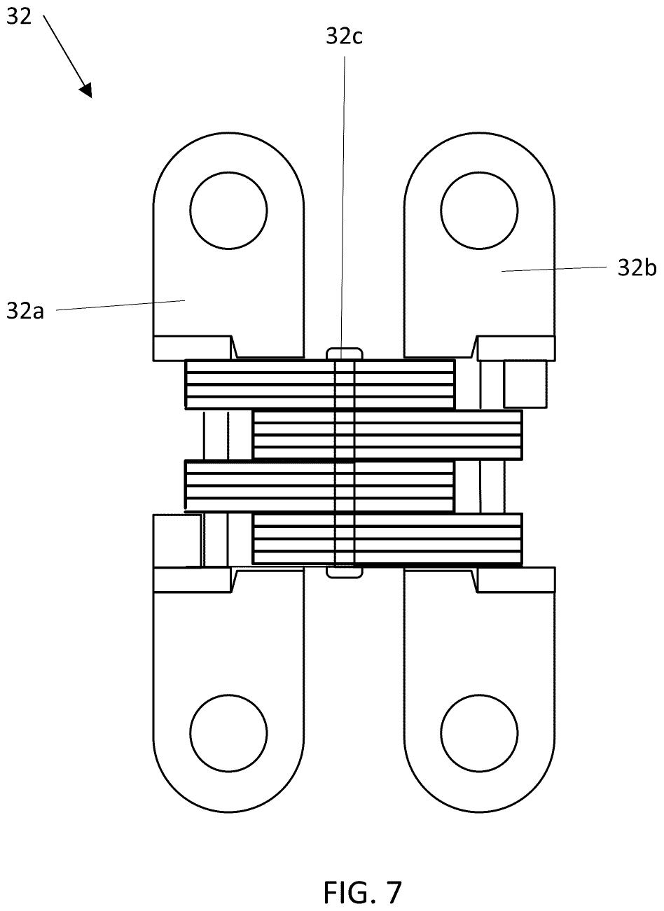

Referring now to the drawings, FIGS. 1-9 illustrate views of exemplary embodiments of a whiteboard system 10 in accordance with aspects of the present subject matter. The whiteboard system 10 includes a base structure 12, a frame structure 14 affixed to the base structure, and a pair of writing panels 16 mounted to the base structure 12 and the frame structure 14 whereby when the frame structure 14 is in a closed position, as shown in FIG. 1, the writing panels 16 are concealed from view. when the frame structure 14 is in an open position, as shown in FIGS. 2 and 3, the writing panels 16 are displayed. In certain aspects, the writing panels and frame structures may be the same size, or in certain aspects the writing panels may be different sizes. In the event that the panels are the same size, the whiteboard system is equipped for internal storage of, for example, markers that are concealed when the whiteboard system is in a closed position. Alternatively and when the writing panels are different sizes, the whiteboard system may be configured for external storage of, for example, markers on a tray or lip formed on a frame structure of the whiteboard system such that the markers are available and exposes when the whiteboard system is in an open or closed configuration. The whiteboard system 10 also includes one or more hinge mechanisms 32 (depicted schematically in FIGS. 1-3). More particularly, the hinge mechanism(s) 32 are hidden when viewed from the exterior, such as when the frame structure 14 is in the closed position. Thus, the hinge mechanism(s) 32 are depicted in phantom in the external views of FIGS. 1 and 4. The hinge mechanism(s) 32 generally couple the frame structure 14 to the base structure 12 such that the frame structure 14 may be moved (e.g., rotated about an axis on the hinge mechanism(s) 32) in order to actuate between the open and closed positions. The hinge mechanism(s) 32 are generally configured to be hidden from view when the frame structure 14 is in the closed position while still allowing the whiteboard system 10 to fully close.

As best shown in FIG. 4, the base structure 12 is adapted to be wall mounted and is generally in the form of a frame 18 constructed of a plurality of frame members 18a-18d. The frame 18 is shown to be rectangular in shape, but it should be appreciated that the frame 18 may be constructed in a variety of geometrical shapes, such as square, triangular, circular, or other fanciful shapes, such as, a star or heart. The base structure 12 may be made of any rigid, durable material, such as wood, plastic, metal, or the like.

The frame structure 14 may be similar in construction to the base structure 12. That is, the frame structure 14 is generally in the form of a frame 24 constructed of a plurality of frame members 24a-24d. The frame 24 is shown to be rectangular in shape, but it should be appreciated that the frame 24 may be constructed in a variety of geometrical shapes, such as square, triangular, circular, or other fanciful shapes, such as, a star or heart. Also, the dimensions of the frame structure 14 may be varied. The frame structure 14 may be made of any rigid, durable material, such as wood, plastic, metal, or the like.

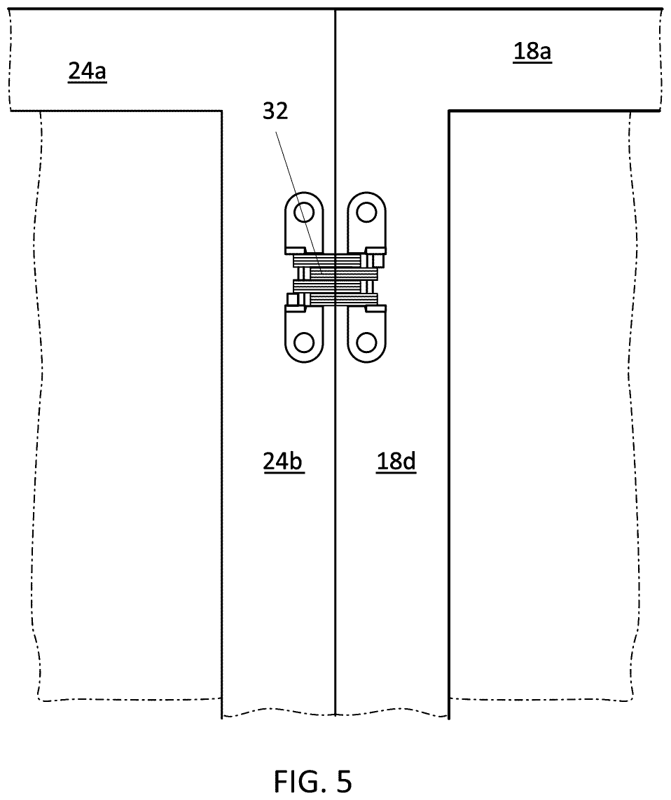

The hinge mechanism(s) 32 are generally allowing the whiteboard system 10 to fully close and be hidden from view when the frame structure 14 is in the closed position. Exemplary embodiments of the hinge mechanism(s) 32, as discussed in more detail with reference to FIGS. 5-8, allow one or more of the frame members 18 of the base structure 12 to contact one or more of the frame members 24 of the frame structure 14 when the whiteboard system is closed. For example, frame member 18a, or an inner surface thereof, may contact frame member 24a, or an inner surface thereof, when the frame structure 14 is in the closed position. Additionally or alternatively, frame member 18b, or an inner surface thereof, may contact frame member 24d, or an inner surface thereof, when the frame structure 14 is in the closed position. Additionally or alternatively, frame member 18c, or an inner surface thereof, may contact frame member 24c, or an inner surface thereof, when the frame structure 14 is in the closed position. Additionally or alternatively, frame member 18d, or an inner surface thereof, may contact frame member 24b, or an inner surface thereof, when the frame structure 14 is in the closed position. In several exemplary embodiments, the respective inner surface of each of the frame members 18 of the base structure 12 may contact a corresponding inner surface of a frame member 24 of the frame structure 14 when the frame structure 14 is in the closed position.

The base structure 12 may be mounted on a wall using conventional picture hanging techniques. For example, the back side of base structure 12 may be provided with keyhole hangers 22 positioned in the top and bottom frame members 18a and 18c. Alternatively, the base structure 12 may be mounted on wall with conventional picture hanging materials, such as wire and hooks.

One or more of the frame members 24b-24d, such as each of the frame members 24b-24d, may be provided with grooves 26b-26d, respectively, along the interior side of the frame members 24b-24d. The grooves 26b-26d cooperate with one another to define a picture receiving space 28. At least one of the frame members 24b-24d (frame member 24a in the exemplary embodiments) is provided with a slot 29 that provides access to the picture receiving space 28 whereby a display panel, for example, a picture, (not shown) may be inserted into or removed from the picture receiving space 28. In one embodiment, the slot 29 has a length extending from the groove 26b to the groove 26d and a width that substantially corresponds with the width of the grooves 26b-26d. The frame structure 14 may be provided with a cavity (not shown) formed on the back side of the frame member 24c for storing and supporting writing utensils, such as markers.

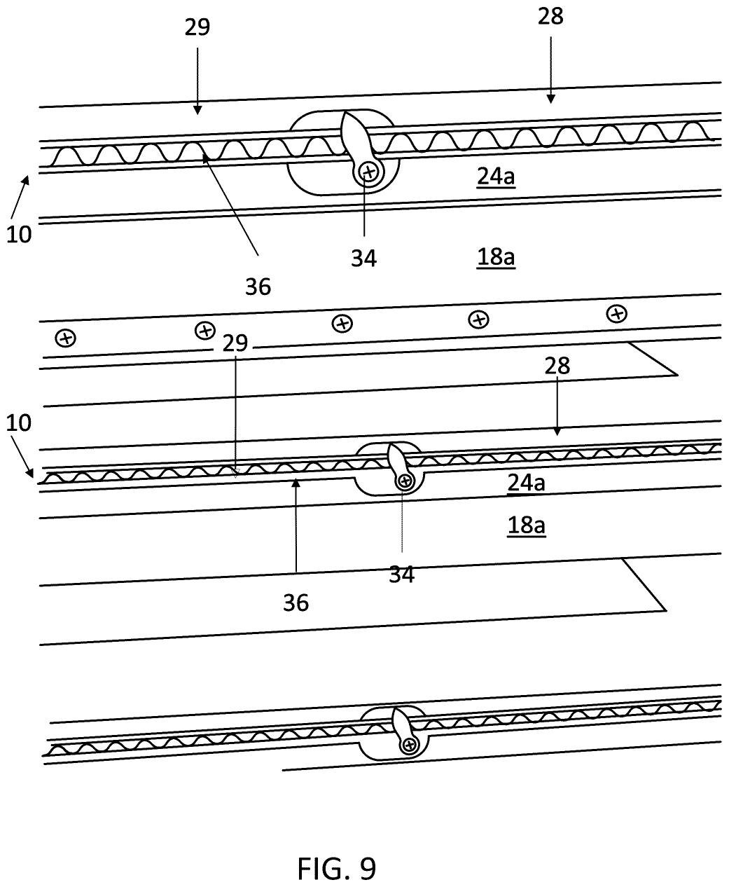

Referring now to FIG. 9, multiple white board systems 10 are illustrated. Particularly, the systems 10 are each illustrated with a media element 36 retained within a corresponding receiving space 28. As shown, the media element 36 may be inserted within slot 29. Additionally, or alternatively, the white board system 10 may include a media retainer 34 associated with the slot 29. The media retainer 34 generally hold the media within the slot 29 and prevents movement within the receiving space. In one exemplary embodiment, the media retainer may be positioned within a depression defined in the frame member defining the slot 29, e.g., frame member 24a. Additionally, or alternatively, the media retainer 24 may include a rotatable lock that may be oriented to prevent the media element 29 from being inserted and removed from the slot. The media retainer may be moved or oriented, such as rotated, in order to allow access to the media element 29. By recessing the media retainer 34 within the frame member 24a, the media retainer 34 not visible when you look at the frame structure 14 from the front or when you are looking at the whiteboard inside.

The writing panels 16 may be dry erase writing panels, which are each superimposed over and mounted to the frames 18 and 24, respectively. The writing panels 16 may be a white smooth faced rigid polypropylene sheet having a sufficient thickness so that the sheet is rigid enough to provide a satisfactory writing surface, yet not so thick as to add needlessly to the overall cost and weight of the whiteboard system 10. In additional or alternative embodiments, one or more of the writing panels 16, such as both of the writing panels 16 may be recessed within the support frame 12 and/or the frame structure 14. In an additional or alternative embodiment, the writing panel(s) 16 may include a steel, iron, and/or ferrous material, such as a backing or a substrate. In such embodiments, the writing panel(s) 16 may be magnetic to that magnetic accessories may be stored in the whiteboard system 10 when the frame structure 14 is in the closed position.

The dry erase writing panels may be fabricated in a conventional manner using a white pigmented polypropylene and molded using conventional extrusion molding techniques. In one embodiment, the pigment is titanium dioxide. The smooth surface enables the user to employ conventional dry wipe markers. These markers are known in the art and are available in the commercial market. One suitable dry wipe marker, for example, is available under the trademark EXPO dry erase marker sold by the Sanford Corp., Bellwood, Ill. These markers use solvent base ink which dries to a powder after it has been applied to a smooth plastic surface. The markers commonly come in different colors for example, red, blue, black and green. It has been determined that the a polypropylene surface, in particular a white pigmented polypropylene panel as above described forms a particularly suitable smooth white surface for receiving conventional solvent base inks used in conventional dry wipe markers. When the user writes on the writing panels 16 using conventional dry wipe markers, e.g., EXPO dry erase markers, the ink easily adheres to the polypropylene surface and can be applied in thick or thin strokes. The ink after it dries will adhere to the polypropylene surface for a considerably long time, for example, at least several months without significantly flaking or otherwise peeling away from the writing surface. The ink may be applied to the surface of polypropylene writing panels 16 even in fine lines. The dry wipe marker ink, e.g., EXPO dry wipe ink when applied to the writing panels 16 readily dries to a powder and may be easily wiped away with a cloth or felt eraser.

Additionally, or alternatively, the writing panels may generally include a dry erase material. Dry erase materials include, but are not limited to, laminated chipboard, high-pressure laminates, steel boards with a matte-finish or glossy coating, enameled or porcelain whiteboards, glass boards, high gloss vinyl, coated paper, high-density two-part high gloss paints, glass and coated acrylics, polypropylene magic whiteboards, clear marker surfaces, specially coated acrylic, and/or the like.

As shown particularly in FIG. 3, the whiteboard system 10 may include one or more magnetic elements 40 associated or coupled with the frame structure 14 and/or the frame members 24 thereof. Similarly, the whiteboard system 10 may include one or more magnetic elements 41 associated or coupled with the base structure 12 and/or the frame members 18 thereof. The magnetic clement(s) 41 of the base structure 12 may be associated with and corresponding with the magnetic element(s) 40 of the frame structure 14, e.g., be of opposite polarity and arranged to be in close proximity when the frame structure 14 is in the closed position. The magnetic elements 40, 41 may generally help to secure the frame structure 14 in the closed position, when desired. Additionally, or alternatively, the magnets 40, 41 may be embedded in the respective structures 12 and 14, such as formed with or included as internal components. Additionally, or alternatively, the magnetic elements may be positioned between the respective structures 12, 14 and the associated writing panel(s) 16, and retained thereby.

While the whiteboard system 10 has been illustrated as having one picture receiving space 28, it should be appreciated that the picture frame structure 14 may be constructed to have a plurality of panel receiving spaces. By way of example, the frame structure may be constructed in the form of two or more frames that are each pivotally attached to the base structure 12 and which open and close similar to French doors with each frame member provided with a picture receiving space.

The whiteboard system 10 of the present invention when in the closed position, as shown in FIG. 1, conceals the writing panels 16 and displays any desired picture or painting disposed in the panel receiving space 26 of the frame structure 14. A display panel, for example, a picture, (not shown) is easily positioned in the frame structure 14 by inserting the picture through the slot 29, which is aligned with the panel receiving space 28. The picture may also be easily removed and replaced with a different picture. When it is desired to use the writing panels 16, a user simply opens the frame structure 14 until the frame structure 14 lies flush against the wall to which the base structure 12 is mounted (FIG. 3).

Referring now particularly to FIGS. 5-8, the whiteboard system 10 may include one or more hinge mechanisms 32 (e.g., a single hinge mechanism extending along at least a portion of the members 18d and 24b as depicted in FIGS. 1, 2, and 4). Additionally, or alternatively, the whiteboard system 10 may include multiple hinge mechanisms arranged along the members 18d and 24b (as depicted in FIGS. 3, 5, and 6). The hinge mechanism(s) 32 may be coupled between the base structure 12 and the frame structure 14. Particularly, the hinge mechanism(s) 32 may be hidden from view when the frame structure 14 is in the closed position while allowing the frame structure 14 to fully close, as described above. The hinge mechanism(s) 32 may be positioned between the base structure 12 and the frame structure 14 when the frame structure 14 is moved to the closed position. Generally, the hinge mechanism(s) 32 is at least partially recessed within the a frame member 18 of the base structure 12, a frame member 24 of the frame structure 24.

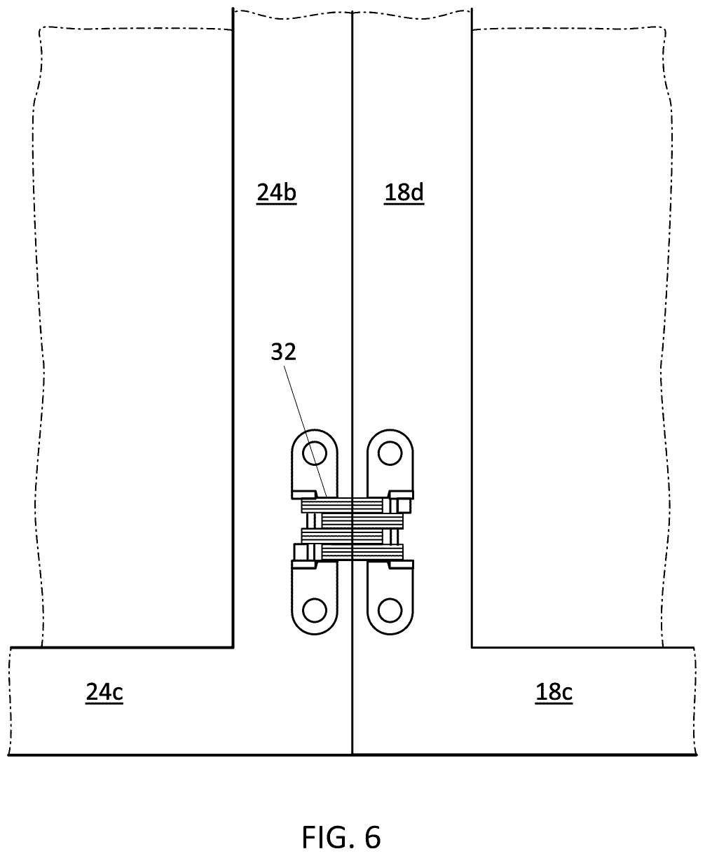

As shown particularly in FIGS. 5 and 6, the whiteboard system 10 may include more than a single hinge mechanism 32, such as two more hinge mechanisms 32. For example, the whiteboard system 10 may include an upper hinge mechanism 32, as shown in FIG. 5. Additionally, or alternatively, the whiteboard system 10 may include a lower hinge mechanism 32, as shown in FIG. 6. Additionally, or alternatively, the hinge mechanism(s) 32 may include more than two hinges mechanisms. In several exemplary embodiments, the hinge mechanism(s) 32 may include a mechanical hinge, such as a mechanical hinge assembly.

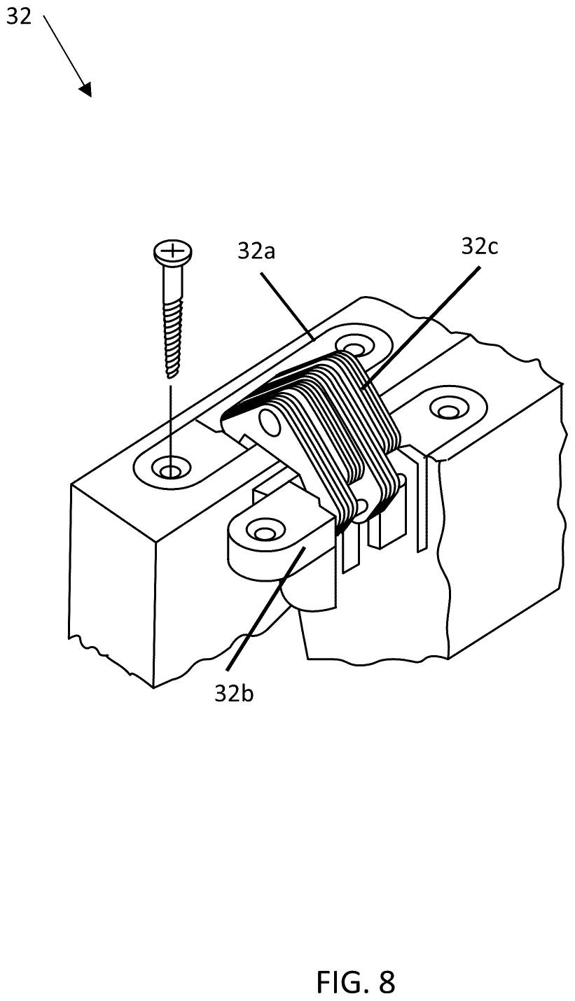

In additional or alternative embodiments, when the frame structure 12 is in the closed position, the hinge mechanism(s) 32 is fully recessed within the base structure 12, the frame structure 14, or a combination of the two. Referring particularly to FIG. 8, an exemplary hinge mechanism 32 is depicted in accordance with aspects of the present subject matter. While FIG. 8 shows the hinge mechanism 32 used in a general nature, it should be appreciated that a frame part 32a of the hinge mechanism 32 may be at least partially recessed, such as fully recessed, within a corresponding frame member (e.g., frame member 24b). Additionally, or alternatively, a base part 32b of the hinge mechanism 32 may be at least partially recessed, such as fully recessed, within a corresponding frame member (e.g., frame member 18d).

As shown, the base part 32b is configured to be fully recessed within frame member 18d. For example, frame member 18d may define a void or cavity configured to accommodate the shape of the base part 32b. Similarly, as shown, frame part 32a may be configured to be fully recessed within a similar whole or cavity defined in frame member 24b. Additionally, or alternatively, a hinge part 32c of the hinge mechanism 32 may generally allow rotation of the frame part 32a (and thus the frame structure 14) about the base part 32b (and thus the base structure 12) about an axis of rotation. As shown, the hinge part 32c may be configured to be fully recessed within corresponding cavities or holes defined in the frame member 18d, frame member 24b, or a combination of the two. The hinge part 32c may generally include a number of members rotatable connected in series. When the frame structure 14 is moved to the closed position, the members of the hinge part 32c may be received within the corresponding cavities or holes defined in the frame member 18d and/or frame member 24b. Additionally, or alternatively, the hinge part 32 may be received a cavity formed with the frame structure 14, is moved to the closed position, e.g., a cavity defined by the writing panel(s) 16 recessed within one or both of the support frame 12 or the frame structure 14.

Generally, when the frame structure 14 is moved to the closed position, the hinge mechanism 32 is fully recessed within one or more holes defined in a frame member 18 of the base structure, a frame member 24 of the frame structure 14, or a combination of the two. Thus, various embodiments of the hinge mechanism(s) 32 disclosed herein allow the whiteboard system 10 to fully close while hiding the hinge mechanism(s) 32 in the closed position.

Furthermore, other suitable configurations of a hinge mechanism(s) would occur to one having ordinary skill in the art, and the present disclosure is equally applicable to a whiteboard system including such a suitable hinge mechanism(s).

The advantages of the present invention include, without limitation, that it is decorative and exceedingly useful to home school parents and professional offices. It is easy to match the decor of a home or office with this picture frame, but still utilize a whiteboard when needed. Matching a standard whiteboard with an established home decor is nearly impossible. Further, the whiteboard is concealed when not in use, with hidden hinge mechanism(s).

This written description uses exemplary embodiments to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A whiteboard system, the system comprising
a base structure adapted to be wall mounted;
a frame structure constructed of a plurality of frame members, the frame structure being affixed to the base structure in such a way that the frame structure is moveable between a closed position and an open position;
and at least one hinge mechanism coupled between the base structure and the frame structure, the hinge mechanism positioned between the base structure and the frame structure when the frame structure is moved to the closed position, wherein the at least one hinge mechanism is at least partially recessed within at least one of the base structure and the frame structure; and
at least one writing panel mounted to at least one of the base structure and the frame structure in such a way that when the frame structure is in the closed position the at least one writing panel is concealed from view by the frame structure, and when the frame structure is in the open position the at least one writing panel is displayed, and wherein the at least one hinge mechanism is configured to be hidden from view when the frame structure is in the closed position.

2. The system of claim 1, wherein each of the frame members has a groove that defines a panel receiving space along an interior side of the frame structure, and at least one of the frame members having a slot that provides access to the panel receiving space such that a display panel may be inserted into and removed from the panel receiving space.

3. The system of claim 2, wherein the at least one writing panel is mounted to at least one of the base structure and the frame structure in such a way that when the frame structure is in the closed position the display panel inserted in the panel receiving space is displayed.

4. The system of claim 1, wherein the frame structure cover defines a first angular orientation relative to the base structure when the frame structure is in the closed position, and wherein the frame structure defines a second angular orientation, different than the first angular orientation, relative to the base structure when the frame structure is in the open position.

5. The system of claim 1, wherein, when the frame structure is in the closed position, the at least one hinge mechanism is fully recessed within at least one of the base structure and the frame structure.

6. The system of claim 1, wherein the at least one hinge mechanism includes a mechanical hinge.

7. The system of claim 1, wherein the at least one hinge mechanism includes a mechanical hinge assembly.

8. The system of claim 1, wherein the at least one hinge mechanism is further configured to allow the whiteboard system to fully close when the frame structure is in the closed position.
